(19) United States
(12) Patent Application Publication
(10) Pub. No.: US 2006/0114273 A1
(43) Pub. Date: Jun. 1, 2006

(54) Display panel

(75) Inventors: Masahiro Okuyama, Inazawa-shi (JP); Koji Hirosawa, Ichinomiya-shi (JP); Yusuke Tsutsui, Anpachi-gun (JP); Yukitada Iwasaki, Mizuho-shi (JP); Yasushi Miyajima, Gifu-shi (JP)

Correspondence Address: MCCARTER & ENGLISH LLP;CITYPLACE I, 185 ASYLUM STREET, HARTFORD, CT, 06103, US

(73) Assignee: SANYO ELECTRIC CO., LTD.

(21) Appl. No.: 11/288,910

(22) Filed: Nov. 29, 2005

Related U.S. Application Data
(60) Provisional application No. 60/634,035, filed on Dec. 7, 2004.

(30) Foreign Application Priority Data
Nov. 29, 2004 (JP) 2004-344978

(51) Int. Cl. G09G 5/10

(52) U.S. Cl. 345/690

(57) ABSTRACT

Test data terminals R-DATA, G-DATA, and B-DATA are provided with respect to video signal lines VL-R, VL-G, and VL-B, via switches SW-R, SW-G, and SW-B, respectively. The switches SW-R, SW-G, and SW-B are turned ON by receiving an H level input signal supplied from a test terminal SW. Thus, a test of a panel is performed before an external IC is connected to the panel. When the external IC is connected to the panel, on the other hand, these terminals used for the test are fixed to an L level, thereby preventing abnormal operations.

### CROSS-REFERENCE TO RELATED APPLICATIONS

Applicant claims the benefit under 35 U.S.C. § 119(e) of U.S. Provisional Application Ser. No. 60/634,035 filed Dec. 7, 2004, the entire disclosure of which is hereby incorporated herein in its entirety. Additionally, Applicant hereby claims the benefit of Japanese Patent Application No. 2004-344978 filed Nov. 29, 2004, under provisions of 35 U.S.C. 119 and the International Convention for the protection of Industrial Property, the entire disclosure of which including specification, claims, drawings and abstract is incorporated herein by reference in its entirety.

### BACKGROUND OF THE INVENTION

1. Field of the Invention

The present invention relates to a display panel comprising at least three video signal lines for individually transmitting R, G, and B video signals, respectively, sampling switches provided on one-to-one correspondence for a plurality of data lines which are connected to the video signal lines, for controlling connection between the data lines and the associated video lines, and a horizontal driver circuit for controlling ON and OFF of the sampling switches, in which a video signal is sequentially supplied to each data line and the video signal is supplied to a pixel which is connected to the data line.

2. Description of Related Art

In LCDs and organic EL displays or the like, flat displays in which a great number of pixels are formed on a single substrate have conventionally been in widespread use. Such a flat display includes an active matrix panel which includes a selection transistor disposed for each of the pixels which are arranged in a matrix for controlling display of each pixel. The active matrix panels are suitable for high density display.

The active matrix panels require a vertical driver for shifting the display line in the vertical direction and a horizontal driver for sequentially supplying a video signal to each pixel in the horizontal direction, so as to supply a video signal which is to be displayed to each of the pixels arranged two-dimensionally.

In the horizontal driver, a horizontal shift register captures a strobe signal of H level indicative of start of one horizontal period and transfers the signal in accordance with a horizontal transfer clock.

By making the horizontal transfer clock synchronous with a video signal for each pixel, it is possible to use an output from the horizontal shift register for opening the sampling switch provided between the video signal line and the data line in each column of the panel, whereby a video signal for each pixel can be supplied to the corresponding data line.

In the vertical driver circuit, on the other hand, by selecting the pixel at a row of the panel to which a video signal is to be supplied, a video signal for each pixel can be supplied to the corresponding pixel.

Many display panels incorporate all of these vertical and horizontal drivers therein. Here, a relatively high speed process is required for the horizontal driver, which must control the operation of processing a video signal and supplying the processed video signal to the data line in each column within one horizontal period. Consequently, many display panels also adopt a structure in which all or part of the horizontal drivers are provided within a separate external semiconductor integrated circuit (IC) and the video signal data lines are supplied from the external IC.

With the above structure in which an external IC is separately provided and is connected to the display panel, however, it is not possible to test an operation condition in a state where the external IC is not attached. However, it is very likely that deficiencies are caused in the transistors or the like which are disposed within the display panel, and there is therefore a demand for the panel test to be performed in a state where the external IC is not attached.

### SUMMARY OF THE INVENTION

In accordance with one aspect of the present invention, there is provided a display panel in which a test can be performed, comprising at least three video signal lines for individually transmitting R, G, and B video signals respectively; a plurality of data lines connected to each of the three video signal lines, where a video signal in each video signal line is sequentially supplied to the associated data line and the video signal is supplied to a pixel connected to the data line; sampling switches provided for the respective data lines for controlling connection between the data lines and the associated video signal lines; a horizontal driver circuit for controlling ON and OFF states of the sampling switches; three video signal terminals connected to the three video signal lines, respectively, for receiving an external video signal; three test video signal terminals connected to the three video signal lines, respectively, for receiving an external test video signal; test switches provided corresponding to the test video signal terminals, respectively, for controlling connection between the test video signal terminals and the video signal lines; and a test switch signal input terminal for receiving a test switch signal for controlling ON and OFF states of the test switches and supplying the test switch signal to the test switches, wherein in a state where a video signal is not input to the video signal terminals, the test switches are turned on by a test switch signal, and R, G, and B test video signals supplied from the respective test video signal terminals are supplied to the associated video signal lines.

Further, the display panel preferably comprises, as the test video signal terminals connected to the three video signal lines, respectively, three additional test video signal terminals, namely a total of six test video signal terminals, and test switches are provided corresponding to these six test video signal terminals.

Also, the display panel preferably comprises a test video signal fixing terminal connected to the test video signal terminals for fixing the potential of the test video signal terminals and a test switch signal fixing terminal connected to the test switch signal input terminal for fixing the potential of the test switch signal input terminal.

Still further, the display panel preferably comprises a signal processing semiconductor integrated circuit IC (external IC) connected to the video signal terminals, the test video signal fixing terminals, and the test switch signal fixing terminal for supplying a corresponding signal to each of these terminals.

In accordance with another aspect of the present invention, there is provided a display panel in which a test can be perforrned, comprising video signal lines for sequentially transmitting R, G, and B video signals for each pixel; a plurality of data lines connected to the video signal lines for individually transmitting the R, G, and B video signals for each pixel to corresponding pixels; a plurality of sampling switches provided corresponding to the respective data lines, for controlling connection between the data lines and the associated video signal lines; video signal terminals connected to the video signal lines, respectively, for sequentially receiving external R, G, and B video signals; a test video signal terminal connected to the video signal lines, for receiving an external test video signal; test switches provided corresponding to the test video signal terminal, for controlling connection between the test video signal terminal and the video signal lines; a test switch signal input terminal for receiving a test switch signal for controlling ON and OFF states of the test switches and supplying the test switch signal to the test switches, and RGB control signal input terminals for receiving an RGB control signal which controls the plurality of sampling switches in accordance with the R, G, and B video signals and which controls such that corresponding video signals are supplied to the data lines, respectively, wherein in a state where a video signal is not input to the video signal terminals, the test switches are turned on by a test switch signal, and R, G, and B test video signals supplied from the test video signal terminal are sequentially supplied to the video signal lines.

In this aspect, it is also preferable to provide a fixing terminal for fixing a signal at the test video signal terminal.

As described above, according to the present invention, at the time of a test, by switching the test switches using a test switch signal, the R, G, and B test video signals can be supplied to the corresponding data lines, respectively. Consequently, in the horizontal driver, a video signal can be sequentially supplied to the corresponding data line to perform a display operation, whereby a panel test can be achieved.

Further, when a dot inversion display method is adopted, it is necessary to sequentially invert the polarity of a video signal. A test can be similarly performed for such a dot inversion display panel by providing two types of test RGB video signals.

In addition, by fixing the potential of the terminals used for a test after completion of the test, it is possible to effectively prevent erroneous operations.

### BRIEF DESCRIPTION OF THE DRAWINGS

Preferred embodiments of the present invention will be described in detail based on the following drawings, wherein:

FIG. 1 is a diagram showing a structure according to one embodiment of the present invention;

FIG. 2 is a diagram showing a structure according to another embodiment; and

FIG. 3 is a diagram showing another example structure.

### DETAILED DESCRIPTION OF PREFERRED EMBODIMENTS

Preferred embodiments of the present invention will be described in detail with reference to the drawings.

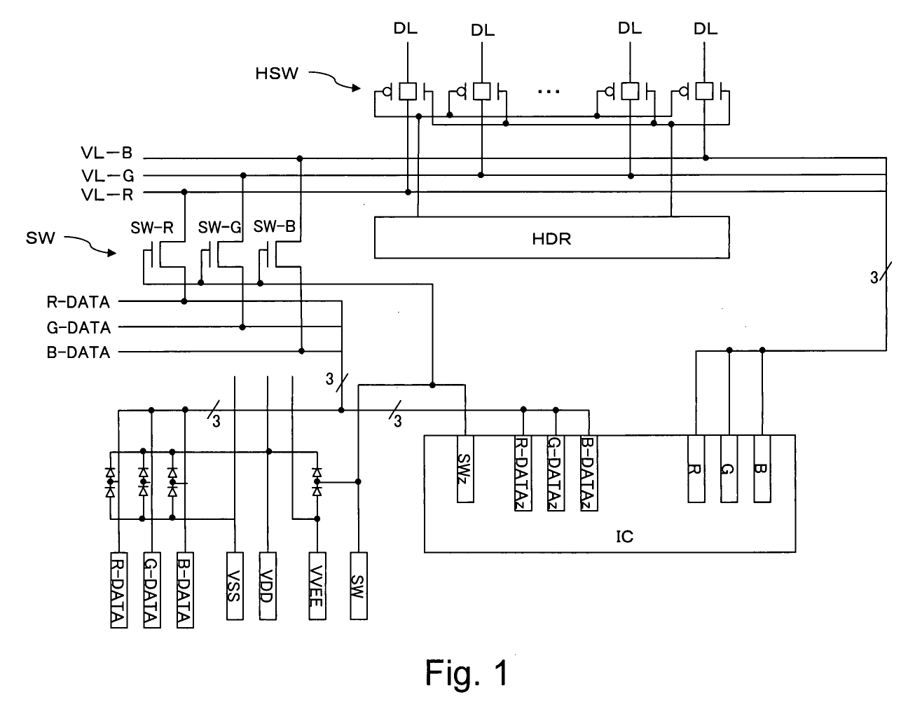

FIG. 1 shows a circuit configuration according to one embodiment of the present invention. The panel shown adopts a line inversion display mode in which the polarity of a video signal is inverted for each line.

One video signal line VL is provided for each of RGB, respectively. Specifically, VL-R which is a video signal line for R, VL-G which is a video signal line for G, and VL-B which is a video signal line for B are provided. R, G, and B data lines are connected to the video signal lines VL-R, VL-G, and VL-B, respectively, via associated sampling switches HSW. Further, a control terminal of each sampling switch HSW is connected to a horizontal driver HDR, and the horizontal driver HDR turns on the sampling switches HSW in the data lines DL corresponding to video signals supplied to the video signal lines VL-R, VL-G, and VL-B, respectively. In this manner, the video signal at each of the video signal lines VL-R, VL-G, and VL-B is sequentially supplied to the corresponding data line DL. Here, the sampling switch HSW is configured such that n-channel and p-channel TFTs (thin film transistors) are connected in parallel. Alternatively, the sampling switch HSW may be constituted by n-channel TFTs only or by p-channel TFTs only.

Each video signal line VL-R, VL-G, or VL-B has a corresponding terminal, to which an external IC which supplies a video signal is connected by COG (chip on glass) technology.

On the other hand, each video signal line VL-R, VL-G, or VL-B is connected to one terminal of each of the test switches SW-R, SW-G, and SW-B, the other terminal of which is connected to each of test data terminals R-DATA, G-DATA, and B-DATA. While the test switches SW-R, SW-G, and SW-B are constituted by n-channel TFTs, they may be constituted by p-channel TFTs. In the latter case, an L level signal is input to turn the test switches ON.

Further, a test switch terminal SW is connected to the control terminal (gate) of each test switch SW-R, SW-G, or SW-B. Consequently, when an H signal is input to the test switch terminal SW, the test switches SW-R, SW-G, and SW-B are turned ON to connect the video signal lines VL-R, VL-G, and VL-B to the test data terminals R-DATA, G-DATA, and B-DATA, respectively, and test data R-DATA, G-DATA, and B-DATA which are externally input are supplied to the video signal lines VL-R, VL-G, and VL-B, respectively.

In addition, an intermediate point of the serially connected two diodes, disposed between a high voltage power source VDD and a low voltage power source VSS is connected to the path from each of the test data terminals R-DATA, G-DATA, and B-DATA to the gate of the corresponding one of test switches SW-R, SW-G, and SW-B. These diodes are connected in such a direction that causes electric current to flow from the low voltage power source VSS to the high voltage power source VDD. Consequently, the potential of the test data terminals is maintained in a range between VSS and VDD, so that any adverse effects caused by static electricity or the like can be eliminated. Here, the power sources VSS and VDD are supplied from the terminals VSS and VDD, respectively. A low voltage terminal VVEE is further provided, and the intermediate point of two diodes disposed between the power sources VDD and VVEE is connected to the test switch terminal SW. Alternatively, it is possible to omit the terminal VEEE and use the terminal VSS instead.

The test data terminals R-DATA, G-DATA, and B-DATA and the test switch terminal SW have corresponding external IC side terminals (R-DATAz, G-DATAz, and B-DATAz, and test switch terminal SWz: test signal fixing terminal), respectively, and these external terminals are connected to the terminal IC. The external IC connects these terminals to −4.5V or ground voltage to thereby fix the voltage.

A test of the panel as configured above, which is performed before the external IC is attached to the panel, will be described.

When this test is to be performed, the external IC is not attached to the panel and therefore the terminals for the external IC are in an open state. In this state, an external test device is connected to the test data terminals R-DATA, G-DATA, and B-DATA and the test switch terminal SW by a flexible printed circuit board (FPC). Further, a power source and a clock for normal operation are supplied to the panel.

Then, an H level signal is supplied to the test switch terminal SW to turn the test switches SW-R, SW-G, and SW-B ON, thereby connecting the video signal lines VL-R, VL-G, and VL-B to the test data terminals R-DATA, G-DATA, and B-DATA. In this state, by supplying test data R-DATA, G-DATA, and B-DATA from the test device to the test data terminals R-DATA, G-DATA, and B-DATA, respectively, these data are supplied to the video signal lines VL-R, VL-G, and VL-B, respectively. Consequently, each of the R pixel, the G pixel, and the B pixel is driven in accordance with the test data, thereby performing the test.

In the above example, only one horizontal driver HDV is provided. However, as it is time-consuming to control data supply to the data lines DL in all the columns with a single horizontal driver HDR, it is preferable to provide a plurality of (thirty-two, for example) horizontal drivers HDR and drive these horizontal drivers HDR in parallel. In this case, it is necessary to provide each of the video signal lines VL-R, VL-G, and VL-B for each horizontal driver HDR in one-to-one correspondence (namely a total of thirty-two video signal lines for each color in the case of thirty-two horizontal drivers). Further, the same number (thirty-two) of RGB video signals from the external IC are also required and these video signals are supplied, in parallel, to the video signal lines VL-R, VL-G, and VL-B.

On the other hand, the number of the test data terminals R-DATA, G-DATA, and B-DATA need not be increased and one for each of the test data terminals R-DATA, G-DATA, and B-DATA would suffice. Further, the test switches SW-R, SW-G, or SW-B are provided in a number corresponding to the number of the associated video signal lines, and each video signal line is connected to one of the test data terminals R-DATA, G-DATA, and B-DATA having the corresponding color. With this structure, during the test, test display is performed at one level for each of RGB colors.

When the panel test as described above is completed, the FPC is disconnected and then the external IC is connected to the panel using the COG technology. Thus, a video signal corresponding to each pixel is supplied to each of the video signal lines VL-R, VL-G, and VL-B. On the other hand, the test switch terminal SW and the test data terminals R-DATA, G-DATA, and B-DATA are fixed at the L level.

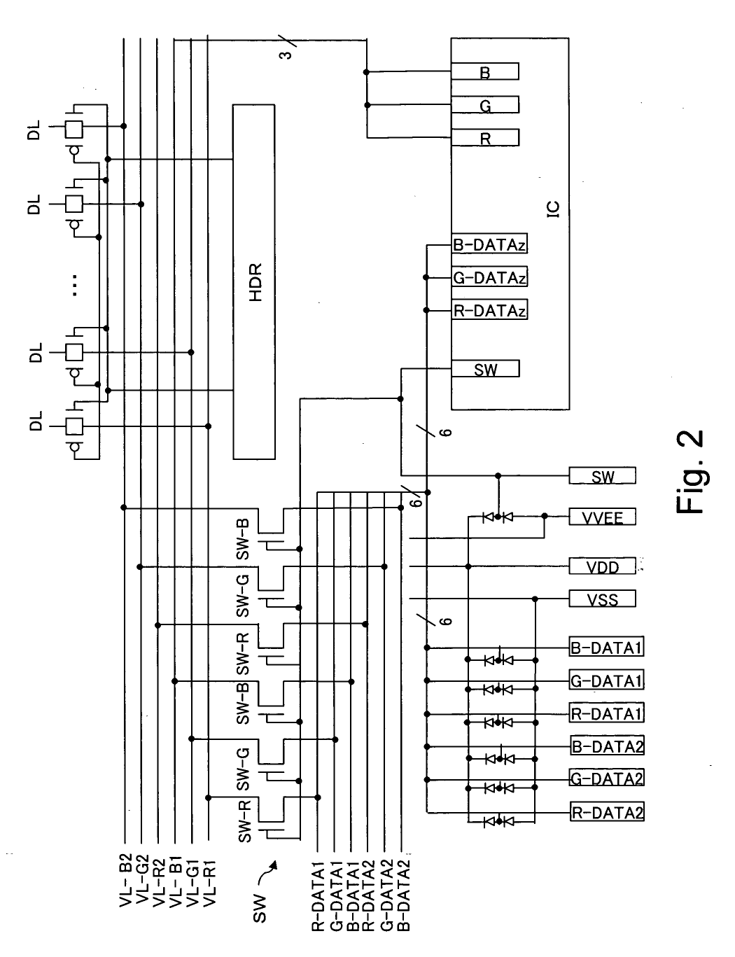

FIG. 2 shows a circuit configuration of an embodiment which adopts a dot inversion display method in which the polarity of a video signal is inverted for each dot.

In the shown example, six test data terminals R-DATA1, G-DATA1, B-DATA1, R-DATA2, G-DATA2, and B-DATA2 are provided. Test data of a first polarity is supplied with regard to R-DATA1, G-DATA1, and B-DATA1, and test data of a second polarity is supplied with regard to R-DATA2, G-DATA2, and B-DATA2. Consequently, the test data of the first or second polarity is selected alternately for each dot, thereby performing dot inversion display.

As described above, according to this embodiment, it is possible to perform a panel test in a dot inversion LCD panel before an external IC is mounted.

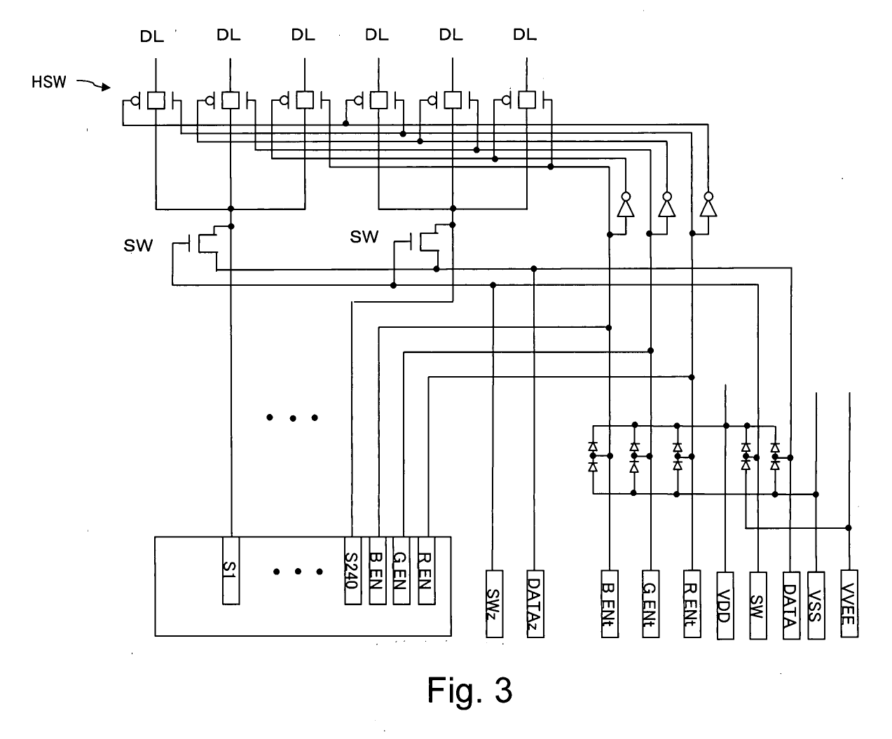

FIG. 3 shows another example structure. The shown panel adopts an HSW method in which video signals from an external IC are written to all the data lines DL collectively.

The external IC is provided with data output terminals S1˜S240, each of which is connected, via three sampling switches HSW, to three data lines DL. Consequently, a total of 720 data lines are provided. The external IC is also provided with three output terminals for enable signals R_EN, G_EN, and B_EN. These three enable signals are connected to the above-described three sampling switches, respectively. The three enable signals R_EN, G_EN, and B_EN one after the other become an H level during one horizontal period. When the signal R_EN is at the H level, an R video signal is supplied to the data output terminals S1˜S240. When the signal G_EN is at the H level, a G video signal is supplied to the data output terminals S1˜S240. Further, when the signal B_EN is at the H level, a B video signal is supplied to the data output terminals S1˜S240. In this manner, RGB data is sequentially supplied to the corresponding RGB data lines, respectively. More specifically, when the signal R_EN is at the H level, the output terminals S1˜S240 sequentially output a video signal with respect to the pixel in each row, and the video signal is then supplied to the data lines of R column. The similar operations are performed with regard to G and B. Consequently, RGB display is achieved for all the pixels.

Further, as terminals for use in a test, a test data terminal DATA, a test switch terminal SW, and three test RGB enable terminals R_ENt, G_ENt, and B_ENt are provided. An intermediate point of the serially connected two diodes disposed between a high voltage power source VDD and a low voltage power source VSS is connected to each of the test data terminal DATA, the test RGB enable terminals R_ENt, G_ENt, and B_ENt, and the test switch terminal SW, whereby a significant change in the terminal voltage caused by static electricity or the like is reduced.

The test data terminal DATA and the test switch terminal SW for switching to a test mode are thus provided, and the test data terminal DATA is connected, via test switches SW, to the paths extending from the terminals S1˜S240 through the corresponding sampling switches HSW. Also, the test switch terminal SW is connected to the gates of the test switches SW. Consequently, when an H level signal is input to the test switch terminal SW, the panel is put into a test mode, and data from the test data terminal is supplied to all the sampling switches HSW.

In addition, terminals DATAz and SWz are further provided so as to eliminate the influence of a voltage change at the test data terminal DATA and the test switch terminal SW after completion of the test. By maintaining these terminals at a sufficiently low voltage of −4.5 V or the like after completion of the test, the lines used for the test can be completely separated from the sampling switches etc.

While the preferred embodiments of the present invention have been described using specific terms, such description is for illustrative purposes only, and it is to be understood that changes and variations may be made without departing from the spirit and scope of the appended claims.

What is claimed:

1. A display panel in which a test can be performed, comprising:
at least three video signal lines for individually transmitting R, G, and B video signals respectively;
a plurality of data lines connected to each of the three video signal lines, a video signal on each video signal line being sequentially supplied to the associated data line and the video signal being supplied to a pixel connected to the data line;
sampling switches provided for the respective data lines for controlling connection between the data lines and the associated video signal lines;
a horizontal driver circuit for controlling ON and OFF states of the sampling switches;
three video signal terminals connected to the three video signal lines, respectively, for receiving an external video signal;
three test video signal terminals connected to the three video signal lines, respectively, for receiving an external test video signal;
test switches provided corresponding to the test video signal terminals, respectively, for controlling connection between the test video signal terminals and the video signal lines; and
a test switch signal input terminal for receiving a test switch signal for controlling ON and OFF states of the test switches and supplying the test switch signal to the test switches,
wherein in a state where a video signal is not input to the video signal terminals, the test switches are turned on by a test switch signal, and R, G, and B test video signals supplied from the respective test video signal terminals are supplied to the associated video signal lines.

2. A display panel according to claim 1, wherein
as the test video signal terminals connected to the three video signal lines, respectively, three additional test video signal terminals, namely a total of six test video signal terminals are provided, and
the test switches are provided corresponding to the six test video signal terminals.

3. A display panel according to claim 1, further comprising:
a test video signal fixing terminal connected to the test video signal terminals for fixing the potential of the test video signal terminals; and
a test switch signal fixing terminal connected to the test switch signal input terminal for fixing the potential of the test switch signal input terminal.

4. A display panel according to claim 3, further comprising
a signal processing semiconductor integrated circuit IC (external IC) connected to the video signal terminals, the test video signal fixing terminal, and the test switch signal fixing terminal for supplying a corresponding signal to each of the terminals.

5. A display panel in which a test can be performed, comprising:
video signal lines for sequentially transmitting R, G, and B video signals for each pixel;
a plurality of data lines connected to the video signal lines for individually transmitting the R, G, and B video signals for each pixel to corresponding pixels;
a plurality of sampling switches provided corresponding to the respective data lines, for controlling connection between the data lines and the associated video signal lines;
video signal terminals connected to the video signal lines, respectively, for sequentially receiving external R, G, and B video signals;
a test video signal terminal connected to the video signal lines, for receiving an external test video signal;
test switches provided corresponding to the test video signal terminal, for controlling connection between the test video signal terminal and the video signal lines;
a test switch signal input terminal for receiving a test switch signal for controlling ON and OFF states of the test switches and supplying the test switch signal to the test switches; and
RGB control signal input terminals for receiving an RGB control signal which controls the plurality of sampling switches in accordance with the R, G, and B video signals and which controls such that corresponding video signals are supplied to the data lines, respectively, wherein
in a state where a video signal is not input to the video signal terminals, the test switches are turned on by a test switch signal, and R, G, and B test video signals supplied from the test video signal terminal are sequentially supplied to the video signal lines.

6. A display panel according to claim 5, further comprising:
a test video signal fixing terminal connected to the test video signal terminal for fixing the potential of the test video signal terminal; and
a test switch signal fixing terminal connected to the test switch signal input terminal for fixing the potential of the test switch signal input terminal.

7. A display panel according to claim 3, further comprising
a signal processing semiconductor integrated circuit IC (external IC) which is connected to the video signal terminals, the test video signal fixing terminal, and the test switch signal fixing terminal for supplying a corresponding signal to each of the terminals.
